(19) United States
(12) Patent Application Publication
(10) Pub. No.: US 2016/0030280 A1
(43) Pub. Date: Feb. 4, 2016

(54) Non-Contact Sonic Treatment for Restless Legs Syndrome

(71) Applicant: Sensory Neurostimulation, Inc., San Clemente, CA (US)

(72) Inventors: Michael L. Jones, San Clemente, CA (US); Fred H. Burbank, San Clemente, CA (US); Alvin Memmolo, San Clemente, CA (US)

(73) Assignee: Sensory Neurostimulation, Inc., San Clemente, CA (US)

(21) Appl. No.: 14/814,395

(22) Filed: Jul. 30, 2015

Related U.S. Application Data
(63) Continuation-in-part of application No. 14/448,748, filed on Jul. 31, 2014, now abandoned.

(51) Int. Cl. A61H 23/02

(52) U.S. Cl. CPC A61H 23/02

(57) ABSTRACT

A device and method for treating restless leg syndrome by transmitting sound proximate the leg or legs of a patient with sound in the range of 20 to 100 Hertz, or 20 to 100 beats per second. The method may be accomplished using sound generators disposed within a pad or sleeve.

This application is a continuation-in-part of U.S. application Ser. No. 14/448,748, filed Jul. 31, 2014.

### FIELD OF THE INVENTION

The inventions described below relate to the field of treatments for restless legs syndrome.

### BACKGROUND OF THE INVENTIONS

Restless legs syndrome (RLS) is common disorder, experienced by many people. Patients suffering from RLS experience various disagreeable sensations in their legs. The symptoms arise when a patient is attempting to fall asleep, or while resting, and do not arise when the patient is active. An episode of RLS (a period during which a patient is actually feeling the sensations of RLS) can be alleviated with activity, but return when the patient tries to return to rest, and that make it very difficult to fall asleep after the onset of an episode of RLS symptoms. RLS symptoms can also occur in the arms of some patients. We have previously established that vibration is a viable treatment for RLS, if applied at the onset of an episode of restless legs syndrome (when the patient is currently experiencing the sensations that characterize restless legs syndrome), rather than applied at a time when the patient is not experiencing symptoms, such as during the day, and if applied at specified amplitude, frequency and duration. This treatment and devices for applying the treatment are described in our previous patent application, Burbank, et al., Devices And Methods For Treating Restless Leg Syndrome, U.S. Pub. 20090221943 (Sep. 3, 2009), the contents of which are hereby incorporated by reference. The device described in our previous patent is FDA cleared for “improving the quality of sleep for patients with primary RLS.” Our previous method of applying vibration included the use of mechanical vibration, provided with mechanisms that impart vibrations at amplitudes of ranging from about 0.002 inches to about 0.75 inch in amplitude directly to the skin of the patient.

We have discovered that RLS may also be treated, and the quality of sleep for patients with primary RLS may be improved, with contactless, or non-contact sound, broadcast near the patient's legs, in such a manner that it does not impart mechanical vibration or physical impact to the patient's body.

### SUMMARY

The devices and methods described below provide for treatment of RLS, and improve the quality of sleep for patients with primary RLS. The devices direct sound near the legs of a patient suffering from RLS symptoms, without impacting the patient's body with mechanical vibration or otherwise providing massage or significant perceptible mechanical vibration to the legs. The devices can be used in a method to treat RLS and improve the quality of sleep for patients with RLS. The method includes placing the device near the patient's body, preferably near the affected limbs, and producing low frequency sound, or beats, without impacting the patient's body with mechanical vibration or otherwise providing massage or significant perceptible mechanical vibration to the legs. Transducers or mechanical noisemakers can be used, and may be mounted in a pad or sleeve which holds the transducer or mechanical noisemaker a slight distance away from the body, sufficient to avoid direct contact between the transducer or mechanical noisemaker. The therapy can be applied at the onset of RLS symptoms, by which we mean the point at which the RLS patient is presently experiencing symptoms, as opposed applying the therapy to an RLS sufferer who experiences symptoms from time to time, but at a time when the RLS sufferer is not presently experiencing the symptoms (such as during the day, hours before symptoms typically occur).

### BRIEF DESCRIPTION OF THE DRAWINGS

FIG. 1 illustrates a patient using a device which provides sound to the patient's body without mechanically impacting the patient's body or applying massage or perceptible mechanical vibrations.

FIGS. 2 and 3 illustrate the device, embodied in a flat pad.

FIG. 4 illustrates a device for applying sound to the patient's limbs using a transducer.

FIG. 5 illustrates a device for applying sound proximate the patient's limbs.

FIG. 6 illustrates the device in the form of a sleeve or brace which fits over the leg of the patient, over the calf and/or thigh of the patient.

### DETAILED DESCRIPTION OF THE INVENTIONS

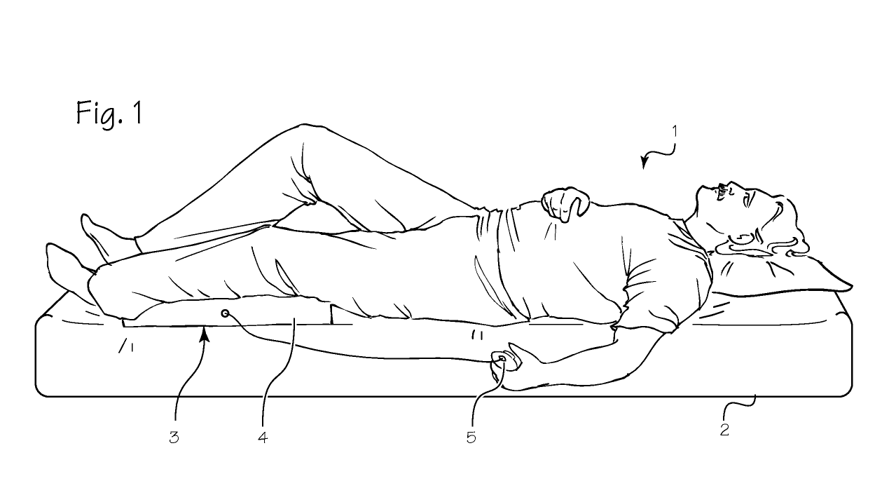

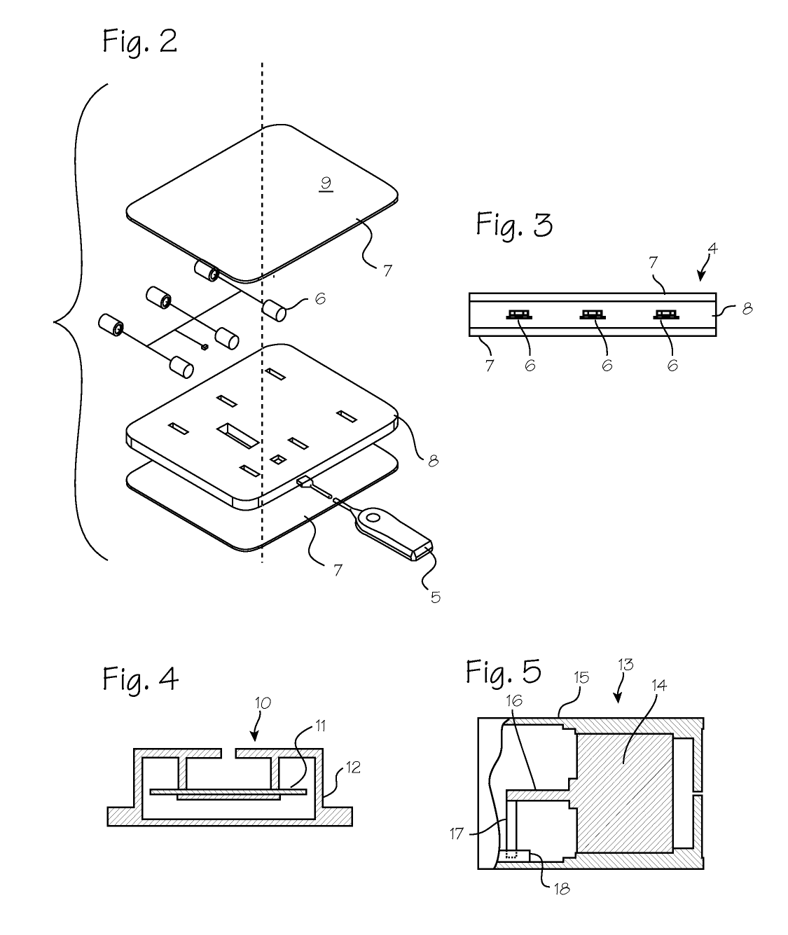

FIG. 1 illustrates a patient using a device which provides sound to the patient's body without applying perceptible mechanical vibrations or mechanically impacting the patient. The patient 1 will typically experience the sensations characteristic of RLS while resting or trying to fall asleep, and so the patient is illustrated in a supine position while lying on a bed 2, though the therapy can be used with the patient in a prone position or while the patient is sitting. The RLS treatment device 3, which is embodied in a pad 4, is shown disposed under the patient's leg (the thigh or the calf). A input device 5 is operable by the patient to start the device and initiate the contactless sound therapy. One or more sound generators 6 in the pad (shown in FIG. 2) are operable to generate and emit sound proximate one or both legs of the patient.

FIGS. 2 and 3 illustrate the RLS treatment device of FIG. 1. As shown in the exploded view of FIG. 2, the device 3 may be constructed as a pad 4 which houses one or more sound generators 6. The pad is preferably flexible, comprising neoprene, foam rubber, or other type of rubber or similarly compliant material suitable for comfortable placement under the legs of the patient. The sound generators are disposed within the pad, in a position within the thickness of the pad so that they are spaced from the surface of the pad, and thus spaced from the surface of the patient's body when the surface of the pad is placed in contact with the patient's body. The stand-off feature can be accomplished by interposing a layer of material 7, such a neoprene, foam rubber, or other type of rubber, or similarly compliant material between the sound generators 6 (and the layer 8 of material within which the sound generators are disposed) and the surface 9 of the pad, as shown in the cross section of FIG. 3. This stand-off layer or isolating layer may be ¼ to ½ inches (6 to 12 mm) thick when made of neoprene. Thus the sound generator is disposed within a few inches of the patient's limb, but preferably at least about ¼ inch (6 mm) away from the skin. The device is controlled by the patient or other operator through the input device 5, which may be a simple switch with an associated power level adjustment, timer or timing circuit, or may operate as an input for a computer control system which in turn is programmed to operate the sound generators as desired.

FIGS. 4 and 5 illustrate sound generators for applying sound to the patient's limbs. These and other means for generating sound can be used to generate sound from broadcast proximate the limbs of the patient to accomplish the method for treating RLS.

FIG. 4 illustrates a sound generator assembly 10 comprising a piezo electric transducer. The sound generator comprises a piezo electric crystal 11 mounted in a casing 12, and associated circuitry and wiring. The sound generator casing is fixed within the pad, at a depth of about 0.25 inches (6 mm), to physically isolate it from the surface of the pad, and thus the surface of the patient's body, to prevent any movement or vibration of the casing from being imparted to the patient as mechanical vibration or massage.

This transducer is operable to provide sound at a frequency in the range of 20 to 100 Hertz (preferably about 20 to 50 Hz). The transducer may produce sound at levels in the range of 55 to 65 decibels (dba), and move at amplitudes of less than 0.1 to 0.2 mils (0.119 to 0.173 mils (0.000119 to 0.000173 inches or 0.003 to 0.004 mm) per cycle of sound, and accelerate during sound generation at rates of less than about 0.5 in/sec², (12 mm/sec²) which is far less that the amplitude 0.002 inches (0.05 mm) to about 0.75 inches (19 mm) and accelerations of 1.2 to 5 in/sec² (30 to 127 mm/sec²) proposed in our prior U.S. application. The sound produced by the transducer may be a pure tone closely limited to a specific frequency, a pure tone and its harmonics and/or subharmonics, a tonal noise (a sound with energy in a very narrow frequency range), a harmonic and/or sub-harmonic of a noise in a narrow audible frequency, or a broadband noise including a component in the 20 to 100 Hertz range, or a perceptible strong, low frequency sound within the 20 to 100 Hertz range with significant noise throughout the audible range.

FIG. 5 illustrates a sound generator assembly comprising a mechanical noise maker 13. The mechanical noise maker comprises a motor 14 disposed within a casing 15. The motor drives a short shaft 16 upon which is mounted a projecting wire or tab 17 which impacts an inwardly projecting tooth 18 on the inside of the motor casing. The motor is operable to rotate the wire to repeatedly impact the tooth, to cause noise characterized by beats at a rate corresponding the rotations per second of the motor. Preferably, the motor is operable to spin the wire at a rate of 20 to 100 rotations per second, to create noise at 20 to 100 beats per second. When implemented with a projecting wire or tab made of nitinol the device will produce a low frequency tone in the range of 20 to 100 Hertz, depending on the speed of the motor.

In prototypes constructed as shown, the mechanical noise maker may produce sound at levels in the range of 55 to 65 decibels (dba), and move at amplitudes of about 0.1 to 0.2 mils (0.119 to 0.173 mils (0.000119 to 0.000173 inches or 0.003 to 0.004 mm) per cycle of sound, and accelerates during sound generation at rates of less than about 0.5 in/sec², which is far less that the amplitude 0.002 inches (0.05 mm) to about 0.75 inches (19 mm) and accelerations of 1.2 to 5 in/sec² (30 to 127 mm/sec²) and proposed in our prior U.S. application. Preferably, the sound generator does not exceed these levels of amplitude and acceleration. The sound produced by the mechanical noise maker may be a pure tone, a pure tone and its harmonics and/or subharmonics, a tonal noise (a sound with energy in a very narrow frequency range), a harmonic and/or sub-harmonic of a noise in a narrow audible frequency, or a broadband noise including a component in the 20 to 100 Hertz range, or a perceptible strong, low frequency sound within the 20 to 100 Hertz range with significant noise throughout the audible range.

The term sound generator assembly as used in reference to FIGS. 4 and 5 refers to a combination of the sound generating mechanism (the piezo electric transducer and associated electric components, or the mechanical noise maker, or other sound generating means) and the casing in which it is housed. This is currently the most convenient form for the sound generators. However, the sound generator assemblies can be formed without the casings, and the operative components may be disposed within the pad, using the pad itself as the structural means for supporting the operative components. Either construction is suitable, so long as the sound generating mechanism and/or any structural components of the sound generator assembly such as the casing are physically spaced from the patient's body when the pad or brace is disposed in contact with the body, such that the patient is isolated from physical vibrations of the sound generator assembly and is not mechanically impacted by the sound generator assembly.

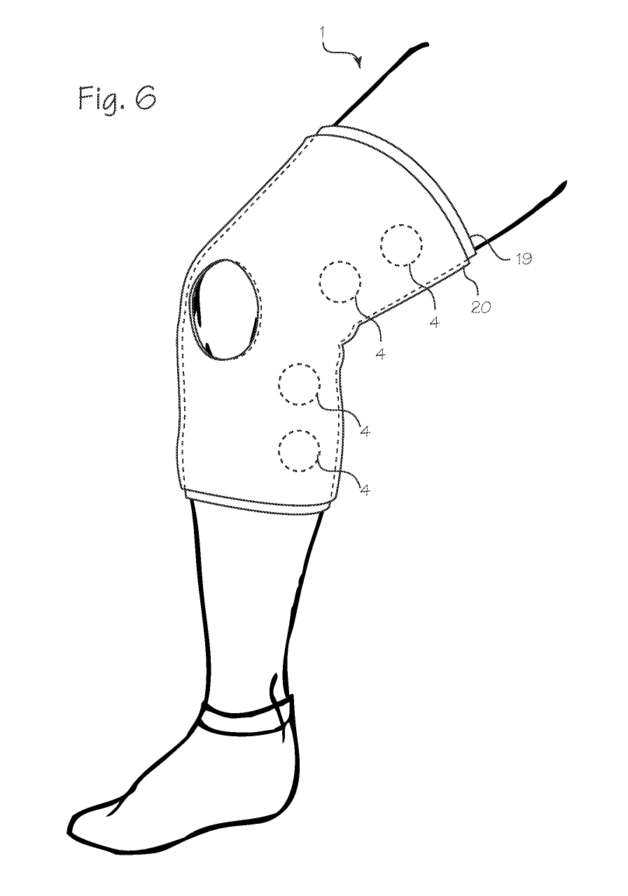

FIG. 6 illustrates the device in the form of a sleeve or brace which fits over the leg of the patient, over the calf and/or thigh of the patient. Most conveniently, this embodiment of the RLS treatment device comprises an isolating layer 19 of material about ¼ to ½ inch thick and one or more sound generators disposed superficially (away from the patient) relative to the isolating layer. The sound generators may be covered with an additional outer layer 20 of sleeve material. The inner layer and outer layer may be formed of discrete sleeves, with the outer sleeve disposed over the inner sleeve and the sound generators sandwiched between the two sleeves, or they may be integrally formed of a single sleeve, with the sound generators embedded within the single sleeve and the thickness between the sound generators and the inner surface of the sleeve constituting the inner layer.

The device may be controlled with a computerized control system or an analog control system operable to optionally (1) adjust the volume of sound generated to suit the patient, (2) adjust the frequency of the sound generated, (3) adjust the length of time the device operates before shutting down and (4) gradually decrease the volume of generated sound prior to shutting down. The control system is also, preferably, operable to control operation of the sound generator to maintain limits on the movement and acceleration expressed above. Where the control system is a computer control system, the patient or other operator may provide input using the input device to instruct the control system to operate the sound generators as desired. The control system is programmed to operate the sound generators to generate sound at the desired volume and frequency, for the desired therapeutic time period, as indicated by the input, and ramp down the volume to zero over a brief time period toward the end of the therapeutic time period.

The devices described above are intended for use in treating RLS and improving the quality of sleep for patients with primary RLS. In use, the patient, upon experiencing the symptoms of RLS, at the onset of an RLS episode in which the patient is presently perceiving symptoms (that is, contemporaneously with the perception of sensation characteristic of RLS), will place the device proximate affected limbs, typically the legs of the patient, without placing the sound generators in contact with the patient's skin, and operate the device to generate sound without mechanically vibrating or massaging or mechanically impacting the skin of the patient. The patient may place the treatment device in direct contact with his/her limbs, or rest directly on the pad, but the pad and isolating layer will effectively dampen any small movements of the sound generators such that the sound generators do not impact the patient. The patient may perceive no physical impacts or vibrations from the sound generating device. Nonetheless, a significant percentage of patients will experience relief from RLS symptoms for the episode during which the therapy is applied. The sound generators may be operated for 5 minutes to 30 minutes, which should be sufficient to act as a counter-stimulation for many patients. At the end of the period, a ramp down in volume of the emitted sound may also be beneficial, so as not to waken or alarm the patient due to sudden stoppage which might awaken the patient.

The sound generators may be incorporated into various means for holding them proximate the body, while holding them spaced from the body surface to avoid contact with the patient's body. The pad described above is one such means. Other useful means may include neoprene sleeves, cloth sleeves, hard braces, and even mattresses and pillows, in which sound generators may be embedded such the surface of the sound generator casing closest to the patient is either (1) covered by isolating material sufficient to dampen any physical motion of the casing or (2) suspended away from the patient's body such that any movement of the casing will not result in contact between the casing and the patient. The sound generators are disposed at a depth within the pad or sleeve such that any motion of the sound generator caused by generation of sound by the sound generator is not transmitted to the body of the patient.

Sufficient material to prevent transmission of mechanical vibration of the sound generator, when the sound generator is disposed with a pad, depends on the nature of the sound generator and the material of the pad. One combination, disclosed above, includes a sound generator comprising a transducer which generates sound while moving no more that 0.000173 inches (0.004 mm) per cycle of sound, may be embedded in a pad comprising neoprene with at least 0.25 inches of the material cover the sound generator (such that, when in use, with the pad in contact with the body of the patient, at least 0.25 inches of the material is disposed between the sound generator and the body).

As used in this specification, “sound” refers to what is typically thought of as sound: pressure oscillations propagated through a medium, and, when in the audible range of human hearing, sensible to the ear but not sensible as impact on the body, and perceived by the sense of hearing and processed by the auditory process. As used in the specification, “mechanical vibration” refers to motion of an object that results in repeated impact on the patient's body with an object or surface, or impingement of an object or surface on the body of the patient in a manner sensed by the sense of touch (such as when sensed through somatic sensory receptors and processed through the cerebral cortex). These are distinct sensory phenomena, and readily distinguishable by artisans and patients. Sound is perceived through the ears while “mechanical vibration” is sensed through the skin.

The distinction drawn in this application between mechanical vibration and impact on the body, on the one hand, and sound, on the other hand, is well-established in the medical arts. Though sound may be caused by mechanical vibration of an object, physicians and artisans involved in treatment of RLS, and artisans involved in the physiological effects of sound and vibration, consider them to be distinct phenomenon. Thus, as used in this specification and in the claims, the term “contacting the patient” refers to actual impact of an object with the body, as in tapping, impacting, or massaging the body with a device, while “sound” refers to propagation of pressure wave through the air and does not include impact of an object with the body sensible as tapping, impact, or massage. “Mechanical vibrations of the sound generator” refers to motion of the sound generator sensible by a patient as actual impact of an object with body (either directly or through any material disposed between the object and the body). Phrases such as “without impacting the patient's body with any mechanical vibrations of the sound generator” refer to avoiding impacting the patient's body with a sound generating device (either directly or through any material disposed between the object and the body), rather than sound generated by the device, in a manner that results in the sensation in the patient of an object contacting the body. Phrases such as “motion of the sound generator caused by generation of sound by” refer to the motion of the sound generator itself, as opposed to oscillations in pressure of the surrounding medium.

While the preferred embodiments of the devices and methods have been described in reference to the environment in which they were developed, they are merely illustrative of the principles of the inventions. The elements of the various embodiments may be incorporated into each of the other species to obtain the benefits of those elements in combination with such other species, and the various beneficial features may be employed in embodiments alone or in combination with each other. Other embodiments and configurations may be devised without departing from the spirit of the inventions and the scope of the appended claims.

We claim:

1. A device for treating Restless Legs Syndrome by emitting sound proximate limbs of a patient, said device comprising:
a sound generator operable to produce sound in the range of 20 to 100 Hertz;
a pad or sleeve, said pad or sleeve characterized by a body contacting surface adapted to contact a limb of the patient;
wherein the sound generator is disposed at a depth within the pad or sleeve such that any motion of the sound generator caused by generation of sound by the sound generator is not transmitted to the body of the patient.

2. The device of claim 1, wherein:
the sound generator comprises a mechanical noise maker disposed with a casing, said casing characterized by a surface; and
the casing is disposed within the pad or sleeve at a depth within the pad or sleeve, such that the casing is spaced from the body contacting surface and the surface of the casing is spaced from the surface of the pad by at least ¼ inch (6 mm).

3. The device of claim 1, wherein:
the sound generator comprises a mechanical noise maker operable to produce sound at 20 to 100 beats per second.

4. The device of claim 1, wherein:
the sound generator comprises a mechanical noise maker operable to produce sound at 20 to 50 beats per second.

5. The device of claim 1, wherein:
the sound generator comprises a piezo electric transducer disposed with a casing, said casing characterized by a surface; and
the casing is disposed within the pad or sleeve at a depth within the pad or sleeve, such that the casing is spaced from the body contacting surface and the surface of the casing is spaced from the surface of the pad by at least ¼ inch (6 mm)

6. The device of claim 1, wherein:
the sound generator comprises a piezo electric transducer operable to produce sound at 20 to 100 Hertz.

7. The device of claim 1, wherein:
the sound generator comprises a piezo electric transducer operable to produce sound at 20 to 50 Hertz.

8. The device of claim 1, wherein:
the sound generator is operable to move at an amplitude not exceeding 0.004 mm per cycle of sound generated by the sound generator.

9. The device of claim 1, wherein:
the sound generator accelerates during sound generation at a rate not exceeding about 0.5 in/sec².

10. The device of claim 1, wherein:
the sound generator generates sound in the range of 55 to 65 decibels.

11. A method of treating Restless Legs Syndrome, said method comprising the steps of:
emitting sound at a frequency of 20 to 100 Hz, proximate a limb of a patient, using a sound generator, without transmitting mechanical vibration of the sound generator to the limb of the patient.

12. The method of claim 11, further comprising the steps of initiating the emitting step at the onset of an RLS episode.

13. The method of claim 11, further comprising the steps of:
providing the sound generator in a pad, with the sound generator disposed within the pad such that the sound generator is covered with sufficient material to prevent any movement or mechanical vibration of the sound generator from being imparted to the patient as mechanical vibration or massage.

14. The method of claim 11, further comprising the steps of:
providing the sound generator in a pad, with the sound generators disposed at a depth within the pad such that the sound generator is spaced from a surface of the pad at a distance sufficient to prevent any movement or mechanical vibration of the sound generator from being imparted to the patient as mechanical vibration or massage.

15. A method of treating Restless Leg Syndrome, said method comprising the steps of:
emitting sound at a frequency of 20 to 100 Hz, proximate a limb of a patient, using a sound generator, without impacting the patient's body with any mechanical vibrations of the sound generator.

16. The method of claim 15, further comprising the steps of initiating the emitting step at the onset of an RLS episode.

17. The method of claim 15, further comprising the steps of:
providing the sound generator in a pad, with the sound generator disposed within the pad such that the sound generator is covered with sufficient material to prevent any movement or mechanical vibration of the sound generator from being imparted to the patient as mechanical vibration or massage.

18. The method of claim 15, further comprising the steps of:
providing the sound generator in a pad, with the sound generators disposed at a depth within the pad such that the sound generator is spaced from the surface of the pad at a distance sufficient to prevent any movement or mechanical vibration of the sound generator from being imparted to the patient as mechanical vibration or massage.

19. The method of claim 13, wherein the step of emitting sound is accomplished with a sound generator which moves at an amplitude less than about 0.000173 inches per cycle of sound, and the sound generator is disposed within the pad at a depth of at least about 0.25 inches.

20. The method of claim 14, wherein the step of emitting sound is accomplished with a sound generator which moves at an amplitude less than about 0.000173 inches per cycle of sound, and the sound generator is spaced from the surface of the pad at a depth of at least about 0.25 inches.
